(19) United States
(12) Patent Application Publication
(10) Pub. No.: US 2009/0043832 A1
(43) Pub. Date: Feb. 12, 2009

(54) METHOD OF DETERMINING AND STORING THE STATE OF A COMPUTER SYSTEM

(75) Inventor: Jack A. Nichols, Kirkland, WA (US)

Correspondence Address: DAVIS WRIGHT TREMAINE, LLP/Seattle, 1201 Third Avenue, Suite 2200, SEATTLE, WA, 98101-3045, US

(73) Assignee: Kivati Software, LLC, Bellevue, WA (US)

(21) Appl. No.: 12/115,476

(22) Filed: May 5, 2008

Related U.S. Application Data
(60) Provisional application No. 60/915,846, filed on May 3, 2007.

(51) Int. Cl. G06F 12/00; G06F 17/30; G06F 12/02

(52) U.S. Cl. 707/205; 707/200; 707/E17.044; 711/E12.001; 711/E12.002

(57) ABSTRACT

A state determination and storage system includes an orchestrator component, guide components, and analyzer components to analyze and store state information for desired portions of a computer system through an extension approach. The system uses extensions to abstract common code for reuse by other extensions. State information is extracted from the extensions and stored. The extensions themselves can be configured to capture partial state information if desired.

### CROSS REFERENCE TO RELATED APPLICATION(S)

This application claims priority benefit of provisional application Ser. No. 60/915,843 filed May 3, 2007, the content of which is incorporated in its entirety.

This application is related to copending application by Jack A. Nichols, entitled “A Method For Differentiating States Of N Machines”, filed on May 5, 2008, which application is hereby incorporated by reference in its entirety, including any appendices and references thereto.

This application is related to copending application by Jack A. Nichols, entitled “A Method Of Determining Dependencies Between Items In A Graph In An Extensible System”, filed on May 5, 2008, which application is hereby incorporated by reference in its entirety, including any appendices and references thereto.

This application is related to copending application by Jack A. Nichols, entitled “A Method For Performing Tasks Based On Differences In Machine State”, filed on May 5, 2008, which application is hereby incorporated by reference in its entirety, including any appendices and references thereto.

### BACKGROUND OF THE INVENTION

1. Field of the Invention

The present invention is directed generally to extensible software systems.

2. Description of the Related Art

Modern computer systems are complex machines and contain a large amount of data. The data stored in a computer system is continually being manipulated and changed by the user, both directly and indirectly; directly in the sense that a user may ask the computer to save a specific set of data to the computer system, and indirectly in the sense that automated processes on the computer may act on behalf of the user to modify the data stored within.

Modern computer systems store data in a variety of mediums. Data storage mediums are either volatile or non-volatile. The content of data in volatile mediums is erased whenever the computer system is powered off. The content of data in non-volatile mediums, by contrast, persists through power cycles.

Volatile mediums in modern computer systems include the main system memory (RAM), the processor's cache memory, the processor's registers, and any other caching systems present in the computer, such as a hard disk cache.

Non-volatile mediums in modern computer systems include hard disks, removable disks, and storage devices (such as floppy disks, CD and DVD discs, USB drives, etc).

While the data stored in volatile mediums is useful for the operation of a computer system, it is the data stored in non-volatile mediums that defines how the computer system operates. Consider two identical pieces of computer hardware A and B. If hardware A contains non-volatile data X, we can make hardware B behave exactly like hardware A by copying non-volatile data X to hardware B. We refer to X as the state of hardware A, and in general the non-volatile data stored in a computer system as the state of the computer system.

Non-volatile data stored in a computer system can include generally can be classified into executable data and non-executable data. Executable data includes data that contains instructions for the computer to perform, such as application programs or an operating system. Executable data is generally responsible for creating and managing non-executable data, such as documents, configurations, etc. Consequently, state is derived from executable data or from non-executable data.

Knowledge of the data storage format of non-executable state data is required in order to read or write the data in a manner that is useful to humans. This knowledge is generally provided by executable state data (application program) to read, write, or otherwise modify the non-executable data. To store and restore the state of a computer system, a storage orchestrator needs knowledge of the data involved. For example, a storage orchestrator understands how to find and read a file on a file system in order to store that file as part of the machine's state. In general, an application program would need impractical modification to provide understanding of the data to be stored by a storage orchestrator. Effectively; the storage orchestrator somehow needs to understand the application itself.

The storage orchestrator also needs to somehow understand that some data is not appropriate to store in certain ways. For example, a storage orchestrator may typically store files in whole, but it may not be appropriate to store an entire database as a single file (assuming that a database is represented in this way). In the case of a database, it may be more appropriate to break open the database file and store the individual tables, columns, rows, etc.

Imbuing a storage orchestrator with knowledge of each and every type of data in a computer system is an approach that is hardly maintainable and that modern software system design practices dictate that the knowledge be separated from the actual storage orchestrator. A common approach for addressing this practice is to implement extensions (sometimes referred to as providers) that the storage orchestrator can then use and load.

Many extensions could be in use by a state storage orchestrator that provides extensibility. These extensions should be able to be identified and should not be in conflict with one another. In the set of extensions provided to a storage orchestrator, many of these extensions may share a great deal of common code for interpreting data and providing it to the storage orchestrator. For example, several extensions may contain logic to navigate through a database's structure, but each extension deals only with one specific type of data, such as a table, column, or row.

Additional extension development may occur after a release of a software system implementing a state storage orchestrator, and that such development may be done by either first or third party. These extensions may wish to make use of the common code used by other extensions, and especially in the case of third party extensions, may find it extremely difficult to do so with ease and efficiency.

The size of the state of a computer system may be very large and may not fit in the computer's main memory or hard disk storage mediums. In particular, it is impractical to expect the state to be stored entirely in main memory since the size of non-volatile data usually exceeds the size of volatile data by a significant amount.

Unfortunately, conventional attempts to store the state of a computer system on the computer system itself have problems. For instance, the size of the stored state could equal the size of the data stored in the non-volatile areas of the computer system. Further, by storing the state data in the non-volatile storage area of the computer, the computer's state itself is being modified.

### BRIEF DESCRIPTION OF THE SEVERAL VIEWS OF THE DRAWING(S)

FIG. 1 is a schematic block diagram of a computer and associated equipment that is used with implementations of the system.

FIG. 2 is an exemplary schematic of the relationship between orchestrator, guide, and analyzer components and extensions.

FIG. 3 is an exemplary schematic of a sample file system structure that could be used as input data by the determination system.

FIG. 4 is a schematic of sample extensions that could be used to analyze the input data depicted in FIG. 2.

FIG. 5 is a schematic of a representative state file produced as output by the determination system.

FIG. 6 is a simplified schematic of the sample input data shown in FIG. 2.

FIG. 7 is a schematic of an empty state file in one embodiment of the determination system.

FIG. 8 is a schematic of the state file at an intermediate point in the execution of one embodiment of the determination system.

FIG. 9 is a schematic of the state file at another intermediate point in the execution of one embodiment of the determination system.

FIG. 10 is a schematic summary of the method aspects related to the determination system.

FIG. 11 is a schematic summary of the method aspects related to the determination system.

### DETAILED DESCRIPTION OF THE INVENTION

As discussed herein, a state determination and storage system includes an orchestrator component, guide components, and analyzer components to analyze and store state information for desired portions of a computer system through an extension approach. The system uses extensions to abstract common code for reuse by other extensions. State information is extracted from the extensions and stored. The extensions themselves can be configured to capture partial state information if desired.

Through its extensions the system is able to use and load extensions created by first and third parties. Aspects of the system include a two-stage provider approach that addresses code sharing issues. Two types of extensions are used by the system: analyzer extensions and guide extensions. An analyzer extension contains logic to read and store state information from objects in a computer system's non-volatile storage. For example, a file analyzer component may examine files on a file system, and store their contents, filename, date, attributes, etc.

A guide extension represents a high-level application or organizational structure whose structure and workings are of interest to many analyzer extensions. The guide provides a navigational context containing sample points for each analyzer, and each analyzer is then free to further analyze the context as it sees fit. Sample points can include but are not limited to files, folders, database tables, database views, database table columns, database table rows, database metadata, database scripts, security descriptors, computer metadata, or other objects or data used by the computer system. For example, a file system guide may first navigate to a directory and ask its analyzers to examine that directory at all or an appropriate amount of sample points. A file analyzer should skip it (because that analyzer only looks at files), but a directory analyzer should analyze and store information about it. Similarly, if the file system guide next navigates to the one or more sample points of a file, the file analyzer should analyze it, and the directory analyzer should skip it.

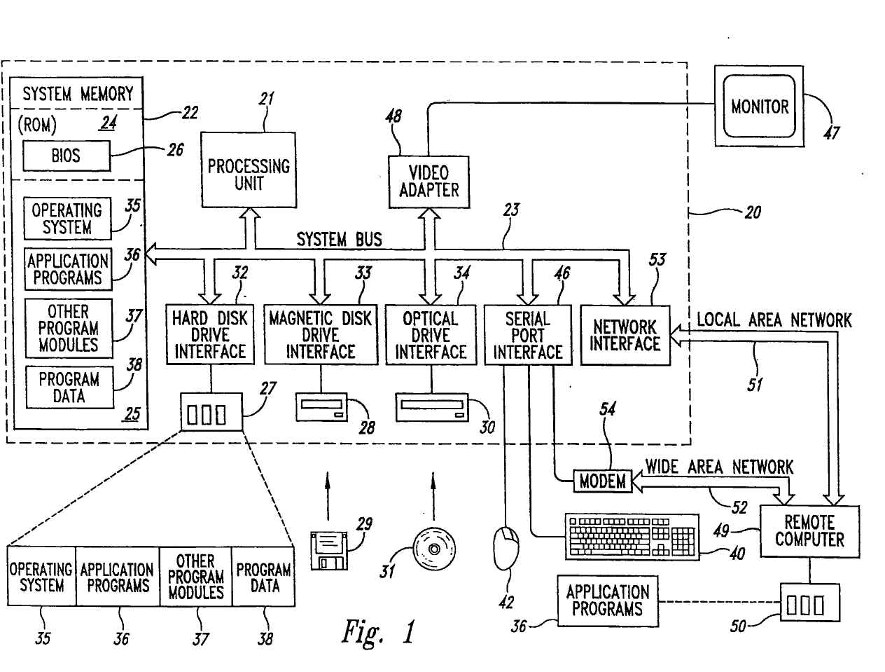

FIG. 1 is a diagram of the hardware and operating environment in conjunction with which implementations may be practiced. The description of FIG. 1 is intended to provide a brief, general description of suitable computer hardware and a suitable computing environment in which implementations may be practiced. Although not required, implementations are described in the general context of computer-executable instructions, such as program modules, being executed by a computer, such as a personal computer. Generally, program modules include routines, programs, objects, components, data structures, etc., that perform particular tasks or implement particular abstract data types.

Moreover, those skilled in the art will appreciate that implementations may be practiced with other computer system configurations, including hand-held devices, multiprocessor systems, microprocessor-based or programmable consumer electronics, network PCs, minicomputers, mainframe computers, and the like. Implementations may also be practiced in distributed computing environments where tasks are performed by remote processing devices that are linked through a communications network. In a distributed computing environment, program modules may be located in both local and remote memory storage devices.

The exemplary hardware and operating environment of FIG. 1 includes a general purpose computing device in the form of a computer 20, including a processing unit 21, a system memory 22, and a system bus 23 that operatively couples various system components, including the system memory 22, to the processing unit 21. There may be only one or there may be more than one processing unit 21, such that the processor of computer 20 comprises a single central-processing unit (CPU), or a plurality of processing units, commonly referred to as a parallel processing environment. The computer 20 may be a conventional computer, a distributed computer, or any other type of computer.

The system bus 23 may be any of several types of bus structures including a memory bus or memory controller, a peripheral bus, and a local bus using any of a variety of bus architectures. The system memory may also be referred to as simply the memory, and includes read only memory (ROM) 24 and random access memory (RAM) 25. A basic input/output system (BIOS) 26, containing the basic routines that help to transfer information between elements within the computer 20, such as during start-up, is stored in ROM 24. The computer 20 further includes a hard disk drive 27 for reading from and writing to a hard disk, not shown, a magnetic disk drive 28 for reading from or writing to a removable magnetic disk 29, and an optical disk drive 30 for reading from or writing to a removable optical disk 31 such as a CD ROM or other optical media.

The hard disk drive 27, magnetic disk drive 28, and optical disk drive 30 are connected to the system bus 23 by a hard disk drive interface 32, a magnetic disk drive interface 33, and an optical disk drive interface 34, respectively. The drives and their associated computer-readable media provide nonvolatile storage of computer-readable instructions, data structures, program modules and other data for the computer 20. It should be appreciated by those skilled in the art that any type of computer-readable media which can store data that is accessible by a computer, such as magnetic cassettes, flash memory cards, digital video disks, Bernoulli cartridges, random access memories (RAMs), read only memories (ROMs), and the like, may be used in the exemplary operating environment.

A number of program modules may be stored on the hard disk, magnetic disk 29, optical disk 31, ROM 24, or RAM 25, including an operating system 35, one or more application programs 36, other program modules 37, and program data 38. A user may enter commands and information into the personal computer 20 through input devices such as a keyboard 40 and pointing device 42. Other input devices (not shown) may include a microphone, joystick, game pad, satellite dish, scanner, or the like. These and other input devices are often connected to the processing unit 21 through a serial port interface 46 that is coupled to the system bus, but may be connected by other interfaces, such as a parallel port, game port, or a universal serial bus (USB). A monitor 47 or other type of display device is also connected to the system bus 23 via an interface, such as a video adapter 48. In addition to the monitor, computers typically include other peripheral output devices (not shown), such as speakers and printers.

The computer 20 may operate in a networked environment using logical connections to one or more remote computers, such as remote computer 49. These logical connections are achieved by a communication device coupled to or a part of the computer 20, the local computer; implementations are not limited to a particular type of communications device. The remote computer 49 may be another computer, a server, a router, a network PC, a client, a peer device or other common network node, and typically includes many or all of the elements described above relative to the computer 20, although only a memory storage device 50 has been illustrated in FIG. 1. The logical connections depicted in FIG. 1 include a local-area network (LAN) 51 and a wide-area network (WAN) 52. Such networking environments are commonplace in offices, enterprise-wide computer networks, intranets and the Internet.

When used in a LAN-networking environment, the computer 20 is connected to the local network 51 through a network interface or adapter 53, which is one type of communications device. When used in a WAN-networking environment, the computer 20 typically includes a modem 54, a type of communications device, or any other type of communications device for establishing communications over the wide area network 52, such as the Internet. The modem 54, which may be internal or external, is connected to the system bus 23 via the serial port interface 46. In a networked environment, program modules depicted relative to the personal computer 20, or portions thereof, may be stored in the remote memory storage device. It is appreciated that the network connections shown are exemplary and other means of and communications devices for establishing a communications link between the computers may be used.

The hardware and operating environment in conjunction with implementations that may be practiced has been described. The computer in conjunction with implementation that may be practiced may be a conventional computer, a distributed computer, or any other type of computer. Such a computer typically includes one or more processing units as its processor, and a computer-readable medium such as a memory. The computer may also include a communications device such as a network adapter or a modem, so that it is able to communicatively couple to other computers.

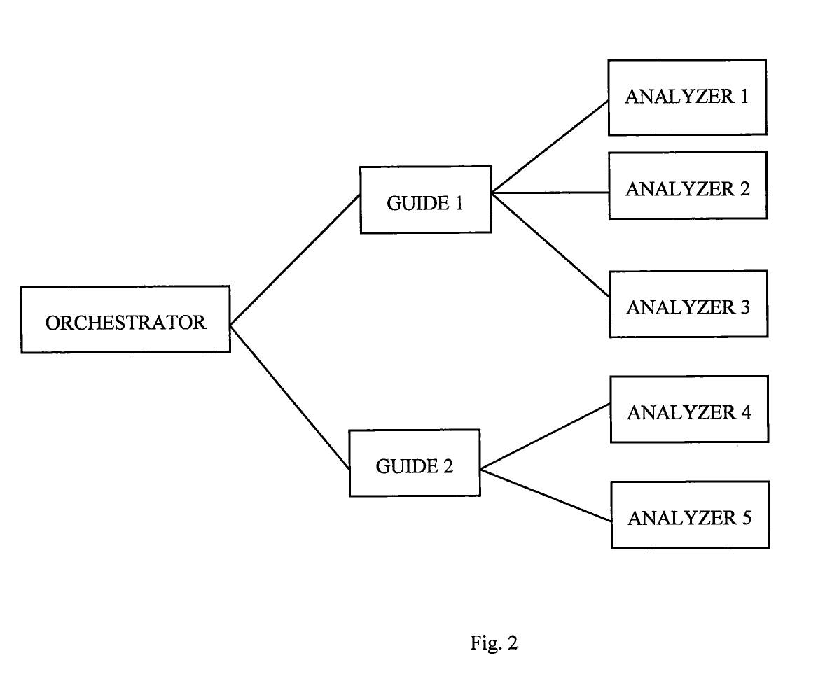

FIG. 2 depicts the relationship between the orchestrator, the guides, and the analyzers.

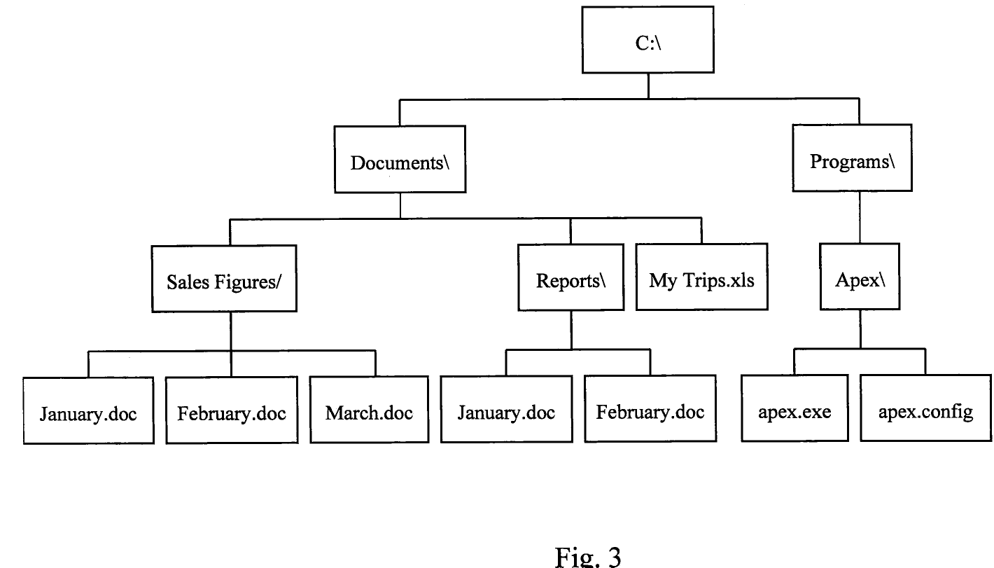

FIG. 3 depicts an exemplary file system structure. Items ending with a trailing slash (“\”) represent directories.

FIG. 3 depicts a portion of the computer system's non-volatile state information. We want to capture this state information in such a way that we can later analyze it or perhaps recreate that state on another machine.

Consider the following extensions:

TABLE 1

| Extension | Type | Description |
|---|---|---|
| File System Guide | Guide | Navigates the file system's |
| | | directories and files. |
| File Analyzer | Analyzer | Stores state information |
| | | about files |
| Directory Analyzer | Analyzer | Stores state information |
| | | about directories |

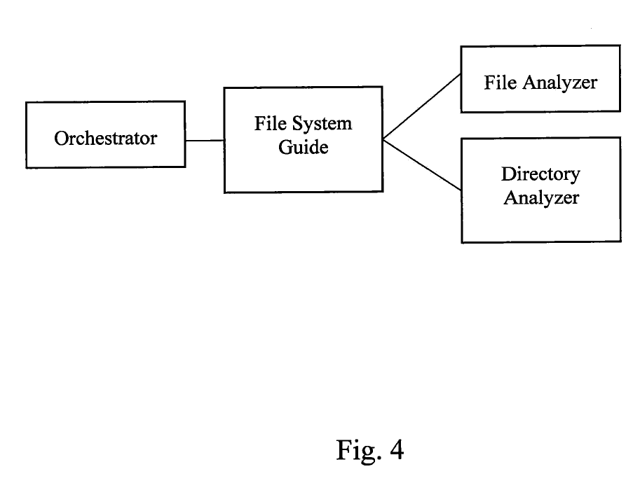

FIG. 4 depicts representation of these extensions.

As a further example, when the orchestrator starts, it initializes all of the extensions and associates the File Analyzer and Directory Analyzer to the File System Guide. The File System Guide is responsible for navigating through the sample points of the directory structure on the hard disk, and it is this extension that the orchestrator communicates with. The extension takes as input a root folder to begin analysis at, and recursively descends through sample points of the file system to each directory. When it encounters a directory or a file, it invokes the analyzers attached to it. The analyzers then can evaluate the data that is provided to them and store the state information as appropriate.

The degree of detail to which the guide provides navigational information to the analyzers is up to the designer of the guide. In the example presented above, the file system guide walks through the file system and stops at directories and files, which is, in actuality, the entirety of a file system. However, if a database guide were to be implemented and used, it may choose only to navigate to major structures, such as tables and views. The analyzers attached to it could then interpret the concept of a table as necessary. For example, a database column analyzer would take the table and look only at its columns, whereas a database row analyzer would look at the data stored in the table's rows. This system grants the authors of both guides and analyzers the flexibility they need to reduce complexity and simplify development of their extensions.

As shown, the orchestrator does not directly address the analyzers, but instead communicates with the analyzers through the guide extensions. Analyzers should be associated with the proper guide, or corruption and errors could result. In order to perform the matching of analyzers to guides, each guide declares its unique name, and each analyzer declares the guide name it matches to. The orchestrator can then match these declarations up to associate the correct analyzers with the correct guide.

Analyzers are ultimately responsible for providing the state information back to the orchestrator. In doing so, the orchestrator should expose to each analyzer a procedure that they can call to provide this information. When this procedure is called and the proper information is passed, the orchestrator should store the state provided in the state file. Analyzers do not need to know how or where the state information is stored, therefore, only that they should call the procedure to store state information.

In order to use the orchestrator properly, the extensions attached to it may need to be configured. Configuration may be necessary in order for the user to tell each extension how to behave. For example, the user may tell the file system guide in the diagram above to analyze only a certain group of drives or directories on the computer's hard disk. The orchestrator places the burden of configuration on each extension because it is not practical for the orchestrator to understand how each extension is to be configured. The exact mechanism for configuration is left to the implementer to decide, as the specifics of that mechanism are not important to the orchestrator, only that each extension be configured properly.

State information can be stored in a variety of mechanisms, such as a file or a database. For the orchestrator to work properly and have good performance characteristics, the state storage location should have the following features:
There should be several separate storage containers available:
   Structure, which contains the actual state information.
   Index, which provides for an index of the state information in the structure container.
Items in the storage containers should be stored and referenced by a unique and predictable key. Each key should be unique in that it should equal no other key except for data that is identical to it, and it should be predictable in that given the data it represents, the key should always be the same, and the key should always be calculable by some known algorithm.
The orchestrator should be able to load only the portions of the storage format that it needs. It should not be required to load the entire structure object into main memory.
The storage format should provide for insertions and lookups into the storage containers that execute in at most O(lg N) time.
The storage format need not provide for delete operations unless a specific embodiment of the invention requires it.

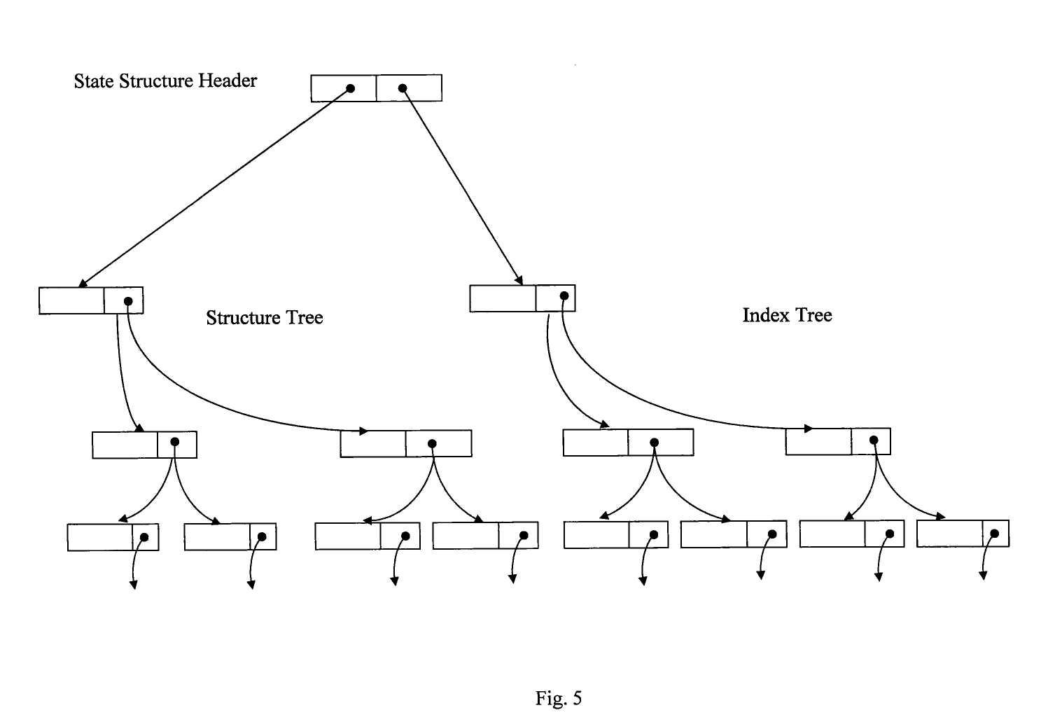

A state file format for an implementation of the system is in FIG. 5. At the top of the diagram is a state structure header. This header contains pointers to the two structures that compose the state file. Each state file is a tree, in this case shown as a simple binary tree, but any tree structure would be acceptable. Each node in each tree in the diagram represents a specific type of data:
In the structure tree, each node represents an item of state data stored by an analyzer extension.
In the index tree, each node represents an index item as required by the specific embodiment. For example, each node in the index tree could represent some property of the state items and could facilitate a reverse lookup.

The exact implementation of the storage containers is a decision to be made by the implementer of the orchestrator. One approach is to use a series of database tables to store this information, but this requires a connection to the database and knowledge of the database's programming interfaces. Another approach is to use a file on the file system, and use a data structure such as a B-Tree to contain the data. This approach is desirable because the B-Tree orchestrator is fast, and the state is self-contained in a file.

The implementer may also choose to add additional storage containers to the state information. In one embodiment of the invention, for example, the implementer may choose to add a metadata tree to store information about the file. Such extra storage of information does not substantially alter or interfere with the operation of the orchestrator.

In one embodiment of the orchestrator, analyzers use the evidence system described in a co-pending patent application entitled, A Method of Determining Dependencies between Items in a Graph in an Extensible System to store soft dependency information. While storing this data isn't strictly required by an embodiment of the system, versions of the orchestrator can store dependency information in a graph, and thus supports metadata (such as evidence used to determine dependencies) to be provided by analyzers. In the example that follows below, this dependency evidence is shown to demonstrate the use of the index tree, however, the index tree can be used for any purpose that is required by the implementer.

After the list of extensions and the storage containers have been determined, the orchestrator can perform its main operations. Consider the following inputs to the pseudocode's main method, BuildTree:
Guides, a list of guides of type Guide. Guide has one property:
   Analyzers, representing the analyzer extensions associated with the guide. Each Analyzer object has a method, Analyze, that takes the following parameters:
      Context, an object representing the guide's context
      StoreState, a function pointer to the method that stores state information in the data file
      StateData, a reference to the data file.
StateData, a data store for the state information. StateData has two properties:
   StateData.Structure, representing the structure tree
   StateData.Index, representing the index tree used to store dependency evidence in this embodiment of the orchestrator

In this embodiment of the orchestrator, the pseudocode also contains other methods that are called by the extensions.
StoreState, which stores state information in StateData. This method is called back by analyzers to store state information. This particular implementation takes as parameters:
   StateData, the data file to store state in
   Key, a unique and predictable key representing the data
   Data, the data to store
   ProducedEvidence, a list of produced dependency evidence to associate with the item
   ConsumedEvidence, a list of consumed dependency evidence to associate with the item

There are two data structures used by StoreState:
StructureNode, a structure tree node as shown above that stores information about each item. It has these properties:
   Key, a unique and predictable key identifying the item
   Data, the data for the item
   ProducedEvidence, the produced evidence for the item
   ConsumedEvidence, the consumed evidence for the item
IndexNode, an index tree node as shown above that stores information about produced evidence in a quick reference index. It has these properties:
   ProducedEvidenceItem, representing the produced evidence item that the node has an index for
   Items, a list of StructureNode objects that produce this evidence.

The pseudocode for the main orchestrator:

```
TABLE 2
Procedure BuildTree(Guides, StateData)
    -- ask each guide to begin navigation, providing to it the
    -- name of the method and the state data reference
    For each Guid P in Guides
        P.BeginNavigate(P, StoreState, StateData)
    -- analysis is complete, and StateData now contains the machine state
End Procedure
Procedure StoreState(StateData, Key, Data, ProducedEvidence,
ConsumedEvidence)
    -- insert a new StructureNode into the structure tree
    StructureNode n = new StructureNode
    n.Key = Key
    n.Data = Data
    n.ProducedEvidence = ProducedEvidence
    n.ConsumedEvidence = ConsumedEvidence
    StateData.StructureTree.Add(n)
    -- store the produced evidence in an index
    For each Evidence X in ProducedEvidence
        -- insert a new IndexNode into the index tree, if one is not
    -- already there
        IndexNode I = null
        if (StateData.IndexTree contains a node with
                IndexNode.ProducedEvidenceItem = X)
            I = StateData.IndexTree[X]
        else
            I = new IndexNode
            I.ProducedEvidenceItem = X
            StateData.IndexTree.Add(I)
        -- add to the list in I
        Add n to I.Items
    -- done
End Procedure
```

The following pseudocode is sample pseudocode for a sample guide extension's BeginNavigate procedure, although guide extensions are free to determine how they wish to operate. This sample is for directories and files on a hard disk:

```
Procedure BeginNavigate(Guide, StoreState, StateData)
    -- get a list of all directories and start generating contexts
    Directories = get all directories on the hard disk
    For each Directory in Directories
        -- this directory is now a context, so call the analyzers
        For each Analyzer in Guide.Analyzers
            Analyzer.Analyze(Directory, StoreState, StateData)
        -- get the files in this directory
        Files = get all files in Directory
        For each File in Files
            -- each file is now a context, so call again
            For Each Analyzer in Guid.Analyzers
                Analyzer.Analyze(File, StoreState, StoreData)
        -- done with this directory
    -- done with this product
End Procedure
```

Finally, the following pseudocode represents a sample analyzer for files. Once again, this is a sample only, and it is up to the implementer of guides and analyzers to determine how they want their extensions to behave:

TABLE 4

```
Procedure Analyze(Context, StoreState, StateData)
    -- if the context is not a file, stop
    if Context is not a file
        return
    -- store information into the state
    StoreState(StateData,
        Context,
        GetFileData(Context),
        PathEvidence of Context,
        PathEvidence of GetParentPath(Context))
    -- done
End Procedure
```

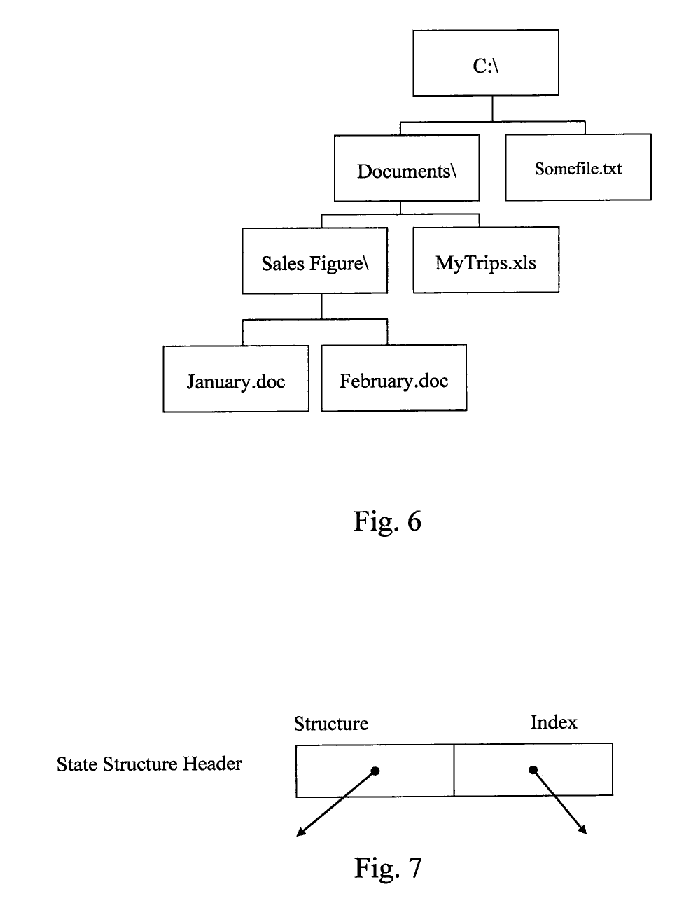

An example of a simple file system can illustrate how the orchestrator works. Consider the file system diagram (a simplified version of the one presented in FIG. 3) as shown in FIG. 6 with the extensions loaded by the orchestrator, as shown in FIG. 4. For illustrative purposes, we'll consider only the File System Guide and File Analyzer without use of the Directory Analyzer.

When the orchestrator is called, the StateData is initially an empty tree as shown in FIG. 7. Note that the structure and index trees are both empty.

The first thing the orchestrator does is begin iterating through the guides. The first (and only, in this example) guide it locates is the File System Guide, and it calls BeginNavigate on the guide with this code:

For each Guide P in Guides
P.BeginNavigate(P, StoreState, StateData)

Our example guide is then invoked, using the pseudocode shown above. According to the pseudocode, the first thing the guide does is read the list of directories on the system:

-- get a list of all directories and start generating contexts
Directories = get all directories on the hard disk

After this line of code, the array Directories should contain these elements:

| | | |
|---|---|---|
| C:\ | C:\Documents\ | C:\Documents\Sales |
| | | Figures\ |

Next, the guide calls all of its analyzer extensions with each directory as a context. A context represents the location at which the guide is currently considering. The first context, therefore, is “C:\”. In our example, because the context is a directory, only the Directory Analyzer would handle this context. The File Analyzer should stop, due to this pseudocode:

if Context is not a file
return

The Directory Analyzer should contain similar code to guard against trying to analyze a file. Each analyzer should have knowledge of the types of data that may be provided by its guide, which is a purpose of the association between analyzers and guides, and is why only a specific subset of analyzers are associated with each guide.

After the “C:\” context has been analyzed, the guide next turns to files in this directory:

-- get the files in this directory
Files = get all files in Directory

After this line of code executes, the array Files will contain just a single element:

C:\Somefile.txt

Now, this array becomes the source of the context. Each analyzer is called with this context:

```
For each File in Files
    -- each file is now a context, so call again
    For Each Analyzer in Guide.Analyzers
        Analyzer.Analyze(File, StoreState, StoreData)
```

Because the context is now a file, the File Analyzer can handle it. The file analyzer passes the first return check shown above, and arrives at the following code wherein it calls the procedure provided to it:

StoreState(StateData,

Context,
GetFileData(Context),
PathEvidence of Context,
PathEvidence GetParentPath(Context))

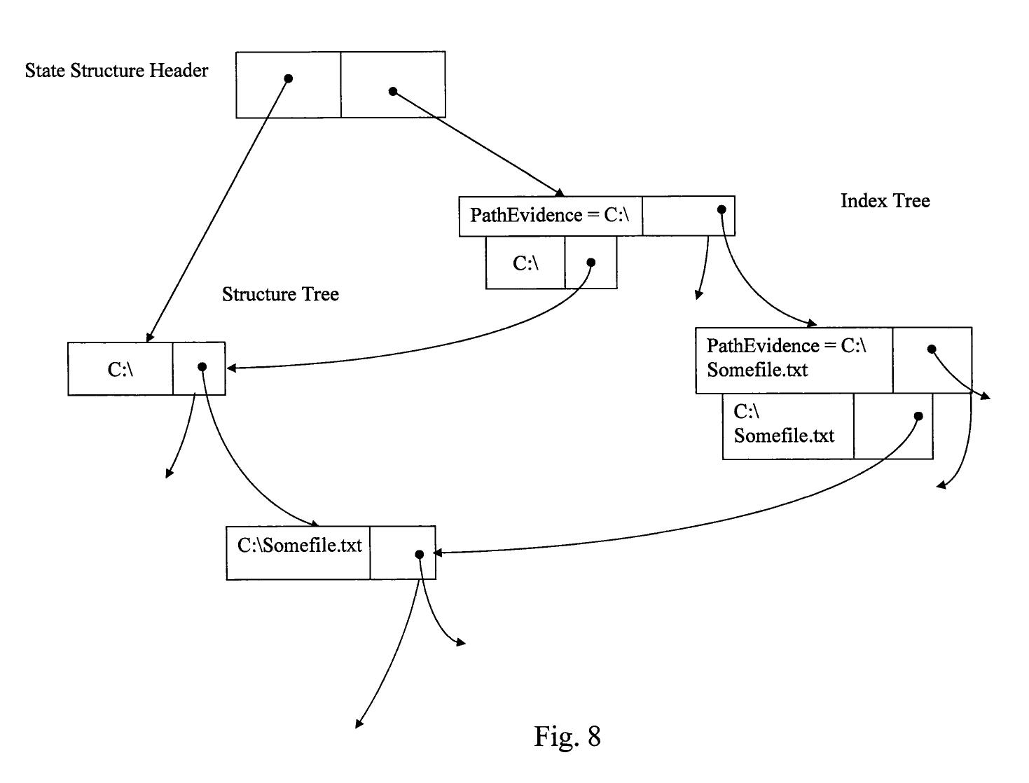

In this example, there are two functions not formally defined, but will be described here. GetFileData loads and returns the contents of the file from the file system. GetParentPath returns the directory in which the file is contained (which is the previous context, “C:\”). The last two parameters to the function represent an instantiation of a Path Evidence item.
The StoreState procedure is now called, and can now insert new nodes into the structure and index trees with this information as depicted in FIG. 8 and shown in the pseudocode. In one embodiment of the invention, the state data file's trees might look like FIG. 8 after both the “C:\” directory context and “C:\Somefile.txt” context. The structure tree contains a node for the C:\directory and for the C:\Somefile.txt file. Not shown here is the data associated with each node, nor the lists of produced and consumed evidence.
The index tree contains a node for the Path Evidence of “C:\”, and another node for the Path Evidence of “C:\Somefile.txt”.
Each node in the index tree contains a list of items that produce that evidence, shown under the node. For example, the Path Evidence of “C:\Somefile.txt” node contains a list of one item pointing back to “C:\Somefile.txt”.
The tree nodes are shown in a binary sort order. However, this is specific to this embodiment of the invention and the specific data structure used, and is not a requirement for the invention to function.

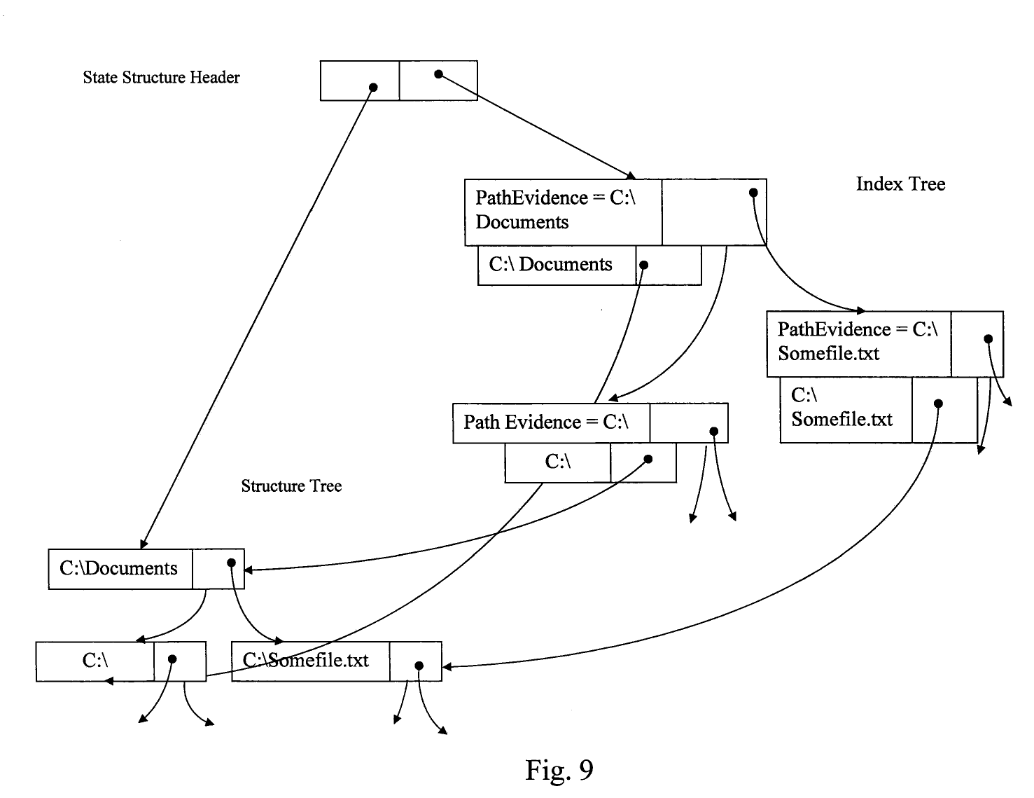

Analysis can now continue with the next directory, “C:\Documents\”. After this item is analyzed by the Directory Analyzer, the state file might look like that depicted in FIG. 9. For the sake of illustration, a full tree has not been shown here, however, the orchestrator can follow the pseudocode to develop a full tree.

This process should continue until all guides have finished navigating their structure, and all analyzers have been called for their applicable contexts. When this is complete, the analysis of the computer system is complete, and the storage location is finalized and closed.

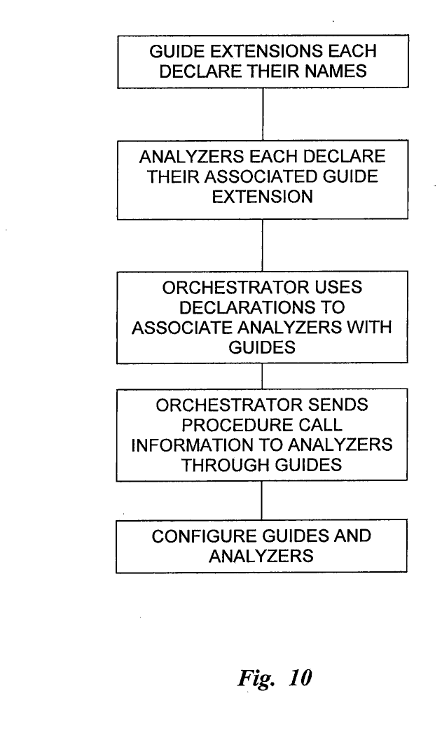

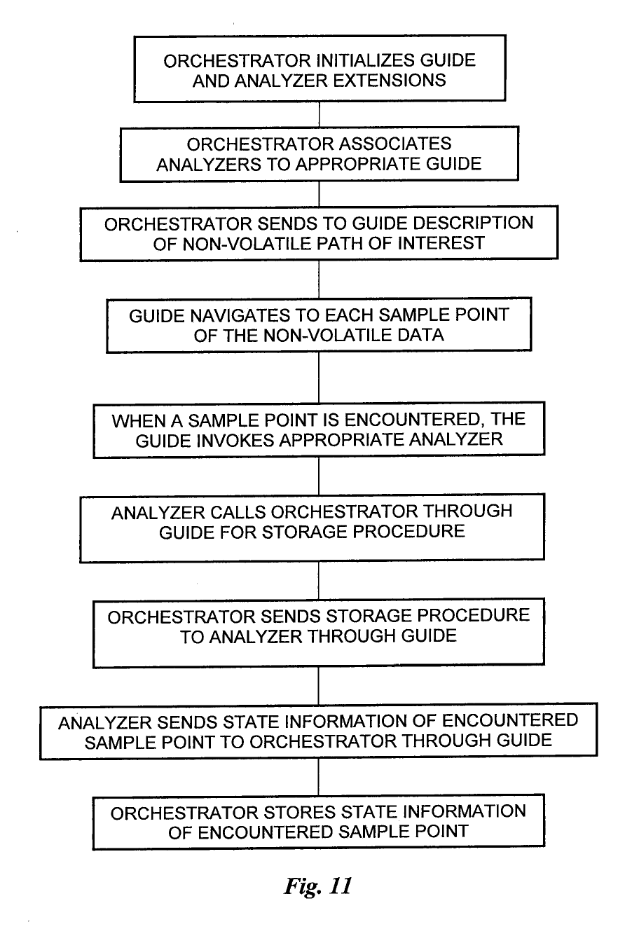

After the state data has been stored, a variety of interesting things can be done with it. One such operation, comparing the differences between two state files, is presented in a co-pending patent application A Method for Differentiating States of N Machines, but other interesting operations are also certainly possible. FIGS. 10 and 11 summarize some of the method aspects of the system discussed.

In one or more various implementations, related systems include but are not limited to circuitry and/or programming for effecting the foregoing-referenced method implementations; the circuitry and/or programming can be virtually any combination of hardware, software, and/or firmware configured to effect the foregoing-referenced method implementations depending upon the design choices of the system designer.

The descriptions are summaries and thus contain, by necessity; simplifications, generalizations and omissions of detail; consequently, those skilled in the art will appreciate that the summaries are illustrative only and are not intended to be in any way limiting. Other aspects, inventive features, and advantages of the devices and/or processes described herein, as defined solely by the claims, will become apparent with respect to the non-limiting detailed description set forth herein.

Those having ordinary skill in the art will also appreciate that although only a number of server applications are shown, any number of server applications running on one or more server computer could be present (e.g., redundant and/or distributed systems could be maintained). Lastly, those having ordinary skill in the art will recognize that the environment depicted has been kept simple for sake of conceptual clarity, and hence is not intended to be limiting.

Those having ordinary skill in the art will recognize that the state of the art has progressed to the point where there is little distinction left between hardware and software implementations of aspects of systems; the use of hardware or software is generally (but not always, in that in certain contexts the choice between hardware and software can become significant) a design choice representing cost vs. efficiency tradeoffs. Those having ordinary skill in the art will appreciate that there are various vehicles by which processes and/or systems described herein can be effected (e.g., hardware, software, and/or firmware), and that the preferred vehicle will vary with the context in which the processes are deployed.

For example, if an implementer determines that speed and accuracy are paramount, the implementer may opt for a hardware and/or firmware vehicle; alternatively, if flexibility is paramount, the implementer may opt for a solely software implementation; or, yet again alternatively, the implementer may opt for some combination of hardware, software, and/or firmware. Hence, there are several possible vehicles by which the processes described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary.

The detailed description has set forth various embodiments of the devices and/or processes via the use of depictions and other examples. Insofar as such depictions and examples contain one or more functions and/or operations, it will be understood as notorious by those within the art that each function and/or operation within such depictions and examples can be implemented, individually and/or collectively, by a wide range of hardware, software, firmware, or virtually any combination thereof.

From the foregoing it will be appreciated that, although specific embodiments of the invention have been described herein for purposes of illustration, various modifications may be made without deviating from the spirit and scope of the invention. Accordingly, the invention is not limited except as by the appended claims.

The invention claimed is:

1. For a non-volatile storage of data having associated sample points and a processor in communication with the non-volatile storage of data, a method for a guide extension running on the processor, the method comprising:
receiving a description of the non-volatile storage of data having the associated sample points, each having a type and associated with a different portion of the non-volatile storage of data;
navigating through the sample points of the non-volatile storage of data;
at each sample point, invoking an analyzer extension of the sample point type to analyze the non-volatile storage of data associated with the sample point for state information;
receiving the state information on the non-volatile storage of data from the analyzer extension; and
passing on the state information.

2. The method of claim 1 wherein the sample points are at least one of the following: files, folders, database tables, database views, database table columns, database table rows, database metadata, database scripts, security descriptors, computer metadata, or other objects or data used.

3. The method of claim 1 wherein the state information is passed to an orchestrator component to store the state information.

4. The method of claim 3 wherein the state information is stored in a plurality of storage containers each having a structure to contain the state information and an index of the state information.

5. The method of claim 3 wherein the state information is stored in a tree format.

6. The method of claim 5 wherein the tree format has a structure tree and an index tree.

7. The method of claim 5 wherein the tree format may be a binary tree, database, or other storage format suitable for representing the tree format.

8. The method of claim 5 wherein the tree format includes a metadata tree.

9. The method of claim 3 wherein the orchestrator includes storing dependency information.

10. For a non-volatile storage of data having associated sample points and a processor in communication with the non-volatile storage of data, a method for an orchestrator component running on the processor, the method comprising:
sending a description of the non-volatile storage of data to a guide extension, the non-volatile storage of data having the associated sample points, each having a type and associated with a different portion of the non-volatile storage of data;
receiving state information on the non-volatile storage of data for each of the sample points from the guide extension; and
storing the state information.

11. The method of claim 10 wherein the sample points are at least one of the following: files, folders, database tables, database views, database table columns, database table rows, database metadata, database scripts, security descriptors, computer metadata, or other objects or data used.

12. The method of claim 10 wherein the state information is stored in a plurality of storage containers each having as structure to contain the state information and an index of the state information.

13. The method of claim 12 wherein the state information is stored in a tree format.

14. The method of claim 13 wherein the tree format has a structure tree and a index tree.

15. The method of claim 13 wherein the tree format is a binary tree.

16. The method of claim 13 wherein the tree format includes a metadata tree.

17. The method of claim 10 wherein the orchestrator includes storing dependency information.

18. For a non-volatile storage of data having associated sample points and a processor in communication with the non-volatile storage of data, a method comprising:
passing between a orchestrator component and a guide extension a description of the non-volatile storage of data having the associated sample points, each having a type and associated with a different portion of the non-volatile storage of data;
navigating the guide extension through the sample points of the non-volatile storage of data;
at each sample point, invoking an analyzer extension of the sample point type to analyze the non-volatile storage of data associated with the sample point for state information;
passing between the analyzer extension and the guide extension the state information on the non-volatile storage of data from the analyzer extension; and
passing between the guide extension and the orchestrator component the state information.

19. The method of claim 18 wherein the sample points are at least one of the following: files, folders, database tables, database views, database table columns, database table rows, database metadata, database scripts, security descriptors, computer metadata, or other objects or data used.

20. The method of claim 18 wherein the state information is passed to an orchestrator component to store the state information.

21. The method of claim 20 wherein the state information is stored in a plurality of storage containers each having as structure to contain the state information and an index of the state information.

22. For a non-volatile storage of data having associated sample points and a processor in communication with the non-volatile storage of data, a storage media containing instructions readable by the processor to perform a method for a guide extension running on the processor, the method comprising:
receiving a description of the non-volatile storage of data having the associated sample points, each having a type and associated with a different portion of the non-volatile storage of data;
navigating through the sample points of the non-volatile storage of data;
at each sample point, invoking an analyzer extension of the sample point type to analyze the non-volatile storage of data associated with the sample point for state information;
receiving the state information on the non-volatile storage of data from the analyzer extension; and
passing on the state information.
